(19) United States
(12) Patent Application Publication
(10) Pub. No.: US 2023/0202337 A1
(43) Pub. Date: Jun. 29, 2023

(54) Method for exchanging energy, processing unit and vehicle

(71) Applicant: ZF CV Systems Global GmbH, Bern (CH)

(72) Inventor: Janik Ricke, Uetze (DE)

(21) Appl. No.: 18/179,643

(22) Filed: Mar. 7, 2023

Related U.S. Application Data
(63) Continuation of application No. PCT/EP2021/076287, filed on Sep. 24, 2021.

(30) Foreign Application Priority Data
Oct. 2, 2020 (DE) 10 2020 125 849.6

(51) Int. Cl. B60L 53/66; B60L 55/00; B60L 53/62; B60L 53/63; B60L 5/38; B60L 53/14; G06Q 30/0283

(52) U.S. Cl. CPC B60L 53/665; B60L 55/00; B60L 53/62; B60L 53/63; B60L 5/38; B60L 53/14; G06Q 30/0283

(57) ABSTRACT

The disclosure relates to a method for exchanging electrical energy between an energy-storage unit in a vehicle, operated by a vehicle operator, and an energy-user. The energy-storage unit has been configured to store electrical energy long-term. An electrical connection between the energy-storage unit and the energy-user can be configured to exchange energy. In accordance with the disclosure, there is provision that an exchange of energy from the energy-user into the energy-storage unit of the vehicle in a first energy-transmission direction, or from the energy-storage unit of the vehicle to the energy-user in a second energy-transmission direction, takes place, in order to provide an energy service by the vehicle operator. The exchange of energy takes place as a function of an energy price, set by the vehicle operator, for the energy service. The energy price is ascertained as a function of a storage-unit status of the at least one energy-storage unit.

### CROSS-REFERENCE TO RELATED APPLICATIONS

This application is a continuation application of international patent application PCT/EP2021/076287, filed Sep. 24, 2021, designating the United States and claiming priority from German application 10 2020 125 849.6, filed Oct. 2, 2020, and the entire content of both applications is incorporated herein by reference.

### TECHNICAL FIELD

The disclosure relates to a method for exchanging energy between at least one energy-storage unit in a vehicle, in particular a utility vehicle, and a vehicle-external energy-user, to a processing unit, and to a vehicle with a processing unit of such a type for carrying out the method.

### BACKGROUND

It is known to supply vehicles, in particular utility vehicles, with energy via stationary overhead lines which are arranged above a roadway. These overhead lines are part of an energy network in which energy with a certain network voltage and with a certain network frequency is made available via power distributors. Vehicles are able to couple onto the overhead lines in sliding manner via energy-collectors, in order to withdraw energy from the energy network. The electric drive of the vehicle can be supplied with the energy, for instance when a store of energy in the vehicle is to be conserved or a state of charge of the energy-storage unit is too low. This is exemplified in DE 10 2016 208 878 A1, DE 10 2018 206 957 A1 or US 2004/0251691. Furthermore, a recharging of the energy-storage units can take place, in order to bridge stretches that are free of overhead lines. Furthermore, it is known to recharge the energy-storage units in electrically-propelled vehicles via charging stations which are connected to the energy network, or by a direct electrical connection to other vehicles, for instance via a charging cable.

The problem that exists in the case of the electrical supply of vehicles via an overhead line or via a charging station is the network voltage and also the network frequency of the energy network, which have to be kept stable in order to avoid a breakdown of the energy supply, and hence to ensure a durable supply of energy for all coupled vehicles. This should be independent of the number of vehicles that are taking energy from the energy network via the overhead line. However, the more vehicles couple onto the overhead lines and take energy via them, the more the network frequency drops, for example, as a result of which the energy network may be overloaded from a certain point in time and may also fail, at least temporarily.

This problem results from the fact that the power distributors are currently not configured to make sufficient energy available for the rising power demand. Should electromobility gain extensive acceptance, the configuration of the power distributors will therefore be crucial, in order to be able to make sufficient energy available for a high degree of utilization. If one imagines a freeway parking lot where several fast-charging stations have been installed, in order firstly to charge only passenger cars, problems quickly arise in the case of an existing power distributor if utility vehicles are suddenly also to be charged. This is problematic, particularly when many vehicles are being charged simultaneously. This is also correspondingly applicable to the charging of vehicles via the overhead lines. A further problem with the energy supply is the increasing, volatile provision of renewable forms of energy, having an effect mainly on the distribution network via which the energy for the overhead lines is made available.

In order to react to these disadvantages, for an application in a mine there is provision in US 2011/0094841 A1 or US 2015/0090554 A1 to feed braking energy, which is generated in the course of the braking of the mine vehicle, directly into the internal energy network of the mine via the overhead lines, as a result of which a high degree of utilization of the energy network can be compensated, at least temporarily. A disadvantageous aspect of this is that a compensation of the degree of utilization of the network can only take place when enough vehicles are braking.

In US 2013/0158827 it is described, furthermore, how to provide instruction purposefully for a braking procedure for a mining vehicle, in order to feed braking energy into the energy network when another mining vehicle needs energy. A disadvantageous aspect of this is that the vehicle is disturbed in its normal operation by the braking instruction.

For such solutions, in which an energy-storage unit in a vehicle is made available for the purpose of providing a vehicle-external energy service, it is not known from the prior art how a bidirectional exchange of energy—that is, outputting or taking in energy—can be regulated in terms of cost, in order to make the exchange of energy economically sensible for the vehicle operator.

It is an object of the disclosure to specify a method for exchanging energy between at least one energy-storage unit in a vehicle, in particular a utility vehicle, and a vehicle-external energy-user, the method enabling an economically sensible utilization by third parties of the energy-storage unit in the vehicle. It is a further object is to specify a processing unit and a vehicle.

These objects are, for example, achieved by a method, a processing unit and also a vehicle according to the disclosure.

In accordance with the disclosure, a method is disclosed for exchanging electrical energy between at least one energy-storage unit in a vehicle, operated by a vehicle operator, and an energy-user, wherein the at least one energy-storage unit has been configured to store electrical energy permanently, and an electrical connection between the at least one energy-storage unit and the energy-user can be configured to exchange energy, wherein an exchange of energy from the energy-user into the at least one energy-storage unit of the vehicle in a first energy-transmission direction, or from the at least one energy-storage unit of the vehicle to the energy-user in a second energy-transmission direction, takes place, in order to provide a certain energy service by the vehicle operator, wherein the exchange of energy takes place as a function of an energy price, set by the vehicle operator, for the energy service, wherein the energy price is ascertained as a function of a storage-unit status of the at least one energy-storage unit.

Advantageously, the economic conditions under which, or the state of the energy-storage unit in which, an energy service is provided if an energy-user makes a request in any manner for the provision of an energy service are/is set by the vehicle operator itself. In this connection, it is taken into account that, from economic viewpoints, it is not always sensible to take in or to output energy at the same price in order to provide the respective energy service, since differing assumptions have to be made, depending upon the state of the energy-storage unit. The storage-unit status and/or the energy price for the energy service is/are preferably determined dynamically, in order to be able to react to changes. In principle, however, at least the energy price can also be set statically by the vehicle operator.

Any service for which the vehicle operator can make its energy-storage units available temporarily on request may be understood to be an energy service. This may include both an intake of energy and an output of energy, whereby in both cases within the scope of the energy service the energy is not designated for the vehicle's own needs. This may be the case when, for instance, energy is taken into the vehicle's own energy-storage unit or is output from the vehicle's own energy-storage unit for the energy service, in order to compensate for a high or low degree of utilization of an energy network as energy-user, and/or in order to make energy available for the (propulsion) assistance of a further vehicle as energy-user, and/or in order to preserve surplus energy of an energy-user temporarily. A high or low degree of utilization of the energy network may occur by a comparison of a network frequency of the energy network with a center frequency, the network frequency of the energy network being measured, for instance, from the vehicle and/or being communicated to the vehicle in wireless or hard-wired manner, for example by power-line communication (PLC) via a sliding contact on the stationary overhead line or via a communications line in the charging cable.

In this way, the integration of a stationary energy-provision device (overhead line, roadway line, charging station) into the existing network infrastructure can be improved. Accordingly, even if the actual fluctuating power demand of the energy network—that is, an overloading or an underloading of the energy network—is not, or cannot be, regulated via the power distributors, given an appropriately negotiated energy price an attempt can be made purposefully to adjust an equilibrium in the degree of utilization of the energy network by recourse to the energy-storage units in the vehicles that are capable of being coupled. The more vehicles participate in this, the better the energy network can be stabilized, for instance given the appropriate approvals of the network operator and of the vehicle operator in the event of an overloading or underloading.

If overhead lines are installed on mountainous roadways, for instance, the vehicles that are traveling downhill and/or that possess an appropriate energy status and have sufficient storage-unit capacities can in this way propel the vehicles traveling uphill, which have an elevated power demand. For this purpose the energy already being carried along from the energy-storage unit can be utilized purposefully in such a way that the running condition of the vehicle does not change when the energy service is being provided. In this connection, it is entirely conceivable that the feeding of energy can take place at a time when the vehicle does not need any propulsion assistance but the batteries have been fully charged. This surplus energy can then be released for the energy service. In principle, this can also be done at a standstill of the vehicle, to the extent that an appropriate state of charge obtains and the status factor or the energy price permits this.

The energy service for stabilizing the energy network can accordingly be provided, in principle, in any running condition of the vehicle, to the extent that the running condition is not impaired by the energy service. If the vehicle is being propelled electrically by the energy-storage units, the energy-storage unit can accordingly take in energy from the energy network or output surplus energy into the energy network, regardless of the propulsion state, in order to provide the energy service without the operation of the vehicle being impaired thereby. If the vehicle is decelerated and if regenerative power is available as a result, the energy-storage unit can take in this energy completely, or the energy-storage unit can take in only a part and can output the remainder into the energy network, or can output the entire amount of energy transformed by regeneration into the energy network. Supplementally in this case, stored energy from the energy-storage unit can additionally be output from the energy-storage unit into the energy network.

For an energy service of such a type, it can preferably be taken into account that the energy price is set as a function of whether the energy for providing the energy service is transmitted in the first energy-transmission direction or in the second energy-transmission direction. As a result, it can be taken into account that the energy-storage unit is being loaded or used differently when outputting energy than when taking in energy.

For instance, the energy price for the energy service may include an intake-energy price and/or an output-energy price, the intake-energy price specifying the energy price for the transmission of energy in the first energy-transmission direction, and the output-energy price specifying the energy price for the transmission of energy in the second energy-transmission direction. Thereby, it can advantageously be set that the provision of stored energy is compensated differently than the “preserving” of energy.

This is reflected, for instance, by the energy price for the energy service preferably being dependent on a status factor and/or on a purchase price for energy, in which connection for the intake-energy price it preferably holds that intake-energy price=purchase price×(1−status factor), and for the output-energy price it preferably holds that output-energy price=purchase price×(1+status factor), where the status factor characterizes the current storage-unit status of the respective energy-storage unit. Hence the current storage-unit status lowers or increases the purchase price, depending upon whether energy is to be made available or “preserved” in order to provide the respective energy service.

There can preferably be provision that the status factor is created as a function of a state of degeneration of the at least one energy-storage unit and/or as a function of a state of charge of the at least one energy-storage unit, the state of degeneration and the state of charge being weighted for the purpose of ascertaining the status factor, and at least the state of charge being dependent on the energy-transmission direction.

As a result, it is advantageously taken into account that the withdrawal or intake of energy from the energy-storage unit can be made dependent on a state of degeneration and also on the state of charge, since this has an effect on the profitability of the energy service. For instance, a greatly degenerated energy-storage unit is to be assessed differently than an energy-storage unit that is as good as new, which is also to be reflected in the energy price. Supplementally, a depreciation of the energy-storage unit can also be taken into account in the ascertainment of the energy price. The state of charge is also crucial for whether an energy-storage unit can be offered for an energy service. In this connection, it can preferably be taken into account that the state of degeneration and the state of charge are weighted for the purpose of ascertaining the status factor, in which connection an equivalent weighting, for instance, may have been provided, depending upon the type of the energy-storage unit.

There can preferably be provision, furthermore, that the state of degeneration of the at least one energy-storage unit is ascertained as a function of at least one quantity selected from the group consisting of: a storage-unit temperature, a charging and discharging behavior, a cycle stability, a storage-unit age, an ambient temperature, a towing-vehicle voltage, a trailer voltage, these quantities being weighted differently, as a function of the energy-storage unit being used, for the purpose of ascertaining the state of degeneration. Accordingly, a number of quantities can be ascertained or read in that can be taken into account in the ascertainment of the state of degeneration and hence in the ascertainment of the status factor or of the energy price, in order to be able to take a well-founded decision about the profitability or the exact energy price. The respective quantities can, for instance, be ascertained by a state watchdog in the vehicle and transmitted to an external or vehicle-internal processing unit which ascertains therefrom the status factor and also—for instance, in a cost-calculation module—the energy price in accordance with the specifications provided by the vehicle operator.

In order to be able to carry this out reliably for the entire vehicle, each energy-storage unit has preferably been assigned a separate storage-unit status or status factor and/or a separate energy price, so that an electrical connection can be set up, where appropriate, also in storage-unit-selective manner—that is, only for certain energy-storage units in the vehicle. Supplementally, it is accordingly possible to react purposefully to the energy status of the respective energy-storage unit in the vehicle and, where appropriate, also to how high the energy-intake demand and energy-output demand from outside actually are. Thereby, it can also be planned whether the vehicle itself still needs energy from one of the energy-storage units but is able to release the other energy-storage unit for the energy service. In this case, for example, only one of the energy-storage units may accordingly be burdened for the respective energy service.

There can preferably be provision, furthermore, that a coupling signal is generated and output as a function of the storage-unit status or status factor assigned to the at least one energy-storage unit, and/or as a function of the energy price, set by the vehicle operator, for the energy service, whereby, depending on the coupling signal, an electrical connection between the at least one energy-storage unit and an energy-consumer, connected to the energy-user, on the vehicle is formed, a switching device in the vehicle preferably being triggered electrically for this purpose with the coupling signal that is generated and output.

This advantageously simplifies the coupling process, whereby a mechanical or inductive contact preferably obtains between the energy-collectors on the vehicle that are capable of being connected to the energy-storage units and the energy-user, in order to be able to establish an electrical connection, brought about, for instance, by a pantograph or a slide rail on an overhead line or by an inductive energy-collector on a roadway line or by a charging cable connected to a charging station or to another vehicle, or similar. By virtue of an electrical switching as a function of the coupling signal, it is therefore possible to react quickly to a requested energy service.

The coupling signal can preferably be generated in the vehicle, for instance by a vehicle-internal processing unit, or outside the vehicle, for instance by an external processing unit, and transmitted to the vehicle in wireless or hard-wired manner. By this means, a centralized or a decentralized option can be created, in order to control the provision of the energy service. For instance, there may be provision that the external processing unit is an integral part of a cloud infrastructure—for example, software as a service—on which a subprogram is running for generating the coupling signal as a function of the energy price and/or of the storage-unit status or the status factor. Depending on this, the switching device can then be triggered in the vehicle, in order to be able to provide the energy service in the event of an appropriate approval.

There can preferably be provision, furthermore, that it is ascertained supplementally whether an approval by the energy-user obtains, the approval specifying whether the respective energy-user allows, for the purpose of providing the energy service, energy to be transmitted optionally in the first energy-transmission direction and/or in the second energy-transmission direction, the approval being granted by the energy-user as a function of at least one property that has been selected from the group including:

a vehicle-type, a degree of utilization of the energy-user, the storage-unit status assigned to the respective energy-storage unit, and/or the energy price, set by the vehicle operator, for the energy service.

Approvals can accordingly be granted purposefully, since, where appropriate, not every vehicle is entitled or able to provide an energy service according to the invention for the energy-user, and/or the energy-user is not in agreement with the set energy price. Accordingly, there is provision, in particular, that the approval is granted if the energy-user—that is, the energy network or a further vehicle—consents to the energy price, set by the vehicle operator, for the energy service. By this means, the vehicle operator is able to predetermine an energy price that can compensate for an advancing degeneration of the energy-storage unit by reason of the energy service, and for which the vehicle operator is also itself prepared to grant an approval. The energy service is accordingly to be sensible for the vehicle operator from an economic point of view.

In this connection, in the case of an energy service for stabilizing the energy network there may preferably be provision that in the case of a high degree of utilization of the energy network a network-operator approval in the second energy-transmission direction is granted, and in the case of a low degree of utilization of the energy network a network-operator approval in the first energy-transmission direction is granted, to the extent that the energy price is accepted by the network operator. As a result, vehicles are normally only able to provide an energy service with which a load that is too low or too high is compensated. In this case, the approvals are accordingly granted as a function of the current degree of utilization (overloading/underloading).

Furthermore, the network-operator approval may firstly take effect only on hybrid vehicles—that is, a network-operator approval may be selectively denied (or granted) for hybrid vehicles in one or both energy-transmission directions, since these hybrid vehicles can also be propelled without an energy supply. In this connection, for the purpose of granting the network-operator approval it may, for instance, be set as a condition that the hybrid vehicle is to be propelled merely via the non-electric part of the drive, for example the internal-combustion engine, in order to be able to utilize the energy from the energy-storage unit fully for the stabilization of the energy network. The network-operator approval is accordingly granted for only one energy-transmission direction, in which case energy can also be fed into the energy network with the internal-combustion engine via the energy-storage unit.

If, for example, a degree of utilization of the energy network is then still too high or too low, the network-operator approval may take effect also on purely electrically-propelled vehicles—that is, a network-operator approval may be selectively denied (or granted) also for purely electrically-propelled vehicles in one or both energy-transmission directions, in order to avoid a breakdown of the energy network as a result of overloading or underloading. A transmission of energy in the respective other energy-transmission direction, which would bring the degree of utilization back into equilibrium, then preferably continues to be permitted for each type of vehicle. The decoupling of purely electrically-propelled vehicles can preferably also be made dependent on a state of charge of the energy-storage unit and/or on the distance still to be traveled as far as the nearest charging station, so that the network-operator approval takes effect only on purely electrically-propelled vehicles that have a state of charge that is higher than a limiting state of charge, for example 40%, and/or that are still able to reach the nearest charging station even in the case of a feeding of energy into the energy network.

There can preferably be provision, furthermore, that the network-operator approval and/or the vehicle-operator approval and/or a user approval from the operator of the further vehicle is/are transmitted in wireless manner between the vehicle and the energy network and/or the network operator or the vehicle operator of the further vehicle. Thereby, a reliable and fast communication and a fast reaction thereto can take place.

In accordance with the disclosure, furthermore a processing unit has been provided, with which the method according to the disclosure can be carried out, the processing unit having been configured to generate and output a coupling signal in such a manner that an electrical connection between the at least one energy-storage unit in the vehicle and the energy-user can be formed, in order to enable an exchange of energy in a first energy-transmission direction or in a second energy-transmission direction for the provision of an energy service by the vehicle operator,
the processing unit having been configured to generate the coupling signal as a function of an energy price set for the energy service, the processing unit exhibiting a cost-calculation module for this purpose, the cost-calculation module having been configured to ascertain an energy price for the energy service as a function of a storage-unit status of the at least one energy-storage unit.

In order to enable a reliable coordination, there can preferably be provision, furthermore, that the processing unit exhibits a communications unit, the processing unit being able to transmit the energy price to the at least one energy-user in wireless or hard-wired manner via the communications unit, and/or the energy-user being able to communicate to the processing unit via the communications unit whether an approval by the energy-user has been granted, the approval specifying whether the respective energy-user allows, for the purpose of providing the energy service, energy to be transmitted, in particular at the set energy price, optionally in the first energy-transmission direction and/or in the second energy-transmission direction.

A vehicle according to the invention, in particular a utility vehicle, preferably a hybrid vehicle or a fully electrically-propelled vehicle, exhibits at least one electrical switching device, at least one energy-storage unit and also at least one energy-collector capable of being connected thereto, the energy-collector having been configured to be coupled with an energy-user within the scope of the provision of an energy service, the energy-storage unit having been configured to store electrical energy permanently, and
the electrical switching device having been configured to form, depending on a coupling signal output from a processing unit according to the invention, an electrical connection between the at least one energy-storage unit and the energy-collector, in order to enable an exchange of energy, as a function of an energy price, set by the vehicle operator, for the energy service, between the at least one energy-storage unit and the energy-collector that is capable of being coupled, the energy price having been set as a function of a storage-unit status of the at least one energy-storage unit.

In this connection there can preferably be provision that the coupling signal is capable of being generated and output by a vehicle-internal processing unit or is capable of being transmitted to the vehicle in wireless or hard-wired manner by an external processing unit. Hence the calculation of the energy price or the ascertainment of the status factor can take place within the vehicle or externally, by the respective signals and data for the calculation being transmitted in wireless or hard-wired manner from a state watchdog. In the case of an external solution—for instance, via a cloud infrastructure—less computing power is necessary in the vehicle itself, whereas in the case of an in-vehicle solution a faster transmission—for instance, using the vehicle-internal data bus utilized whenever required—is possible without a connection to the outside.

There can preferably be provision, furthermore, that the vehicle includes a towing vehicle and at least one trailer, a towing-vehicle energy-storage unit being arranged in the towing vehicle, and/or a trailer energy-storage unit being arranged in the trailer, the towing-vehicle energy-storage unit and/or the trailer energy-storage unit being capable of being connected, preferably selectively, to the energy-user as a function of the coupling signal, for instance via a stationary energy-provision device and/or a charging cable. Hence a flexible exchange of energy and a recourse to differing energy-storage units which are available in the vehicle for the supply of differing parts of the vehicle can take place. By a selective approval, it can also be taken into account how much energy from which energy-storage unit in the vehicle itself will foreseeably be needed in future.

There can preferably be provision, furthermore, that a converter device for transforming a network voltage and/or a network frequency of the energy network is arranged between the at least one energy-storage unit and the energy-collector. Thereby, a voltage adjustment or frequency adjustment can be made to the voltage or frequency that is being used in the energy network. If direct current is being used in the energy network, a transformation of direct current into alternating current or vice versa (depending upon the energy-transmission direction) in the converter device can be dispensed with.

### BRIEF DESCRIPTION OF DRAWINGS

The invention will now be described with reference to the drawings wherein:

FIGS. 1, 2 each show a schematic view of a vehicle that is coupled to an energy network; and

FIG. 3 shows a flowchart of the method according to the disclosure.

### DETAILED DESCRIPTION

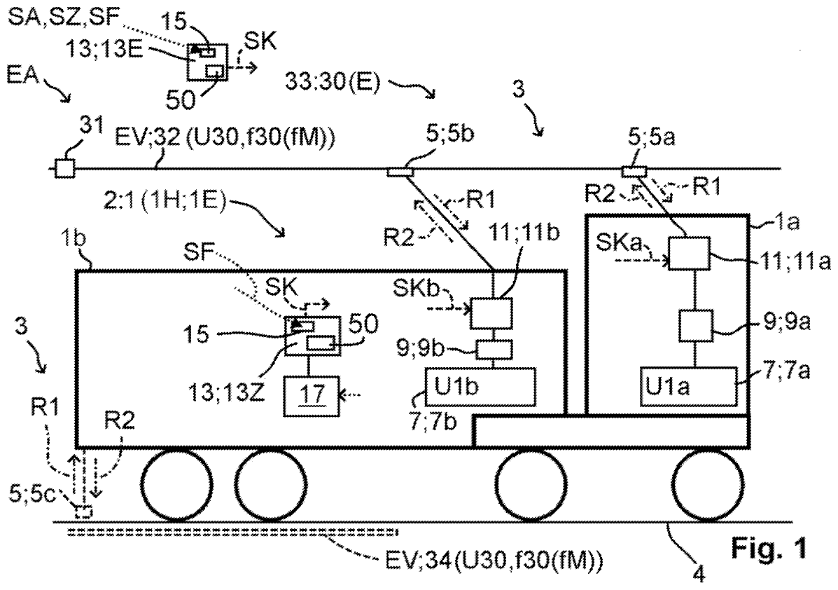

In FIG. 1, a vehicle 1, in particular a utility vehicle, consisting of a towing vehicle 1a and a trailer 1b, is represented schematically which is also designated for the public traffic realm and can therefore also travel on expressways, highways, country roads, et cetera. The vehicle 1 may be a fully electrically-propelled vehicle 1E or an at least partially electrically-propelled hybrid vehicle 1H.

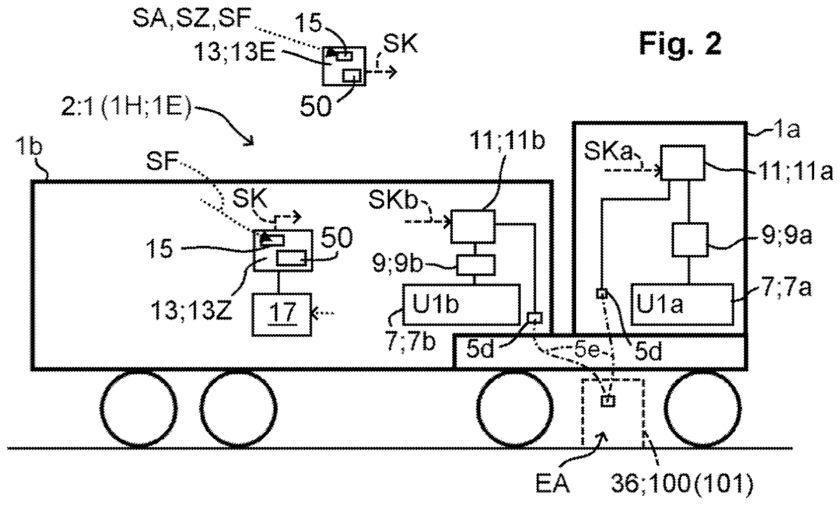

The vehicle 1 exhibits an energy-transmission system 3 via which electrical energy E can be exchanged between the vehicle 1 and an external energy network 30 as energy-user EA, also during travel. Within the energy network 30, power distributors 31 have been provided which make electrical energy E available which is transmitted via stationary overhead lines 32 as stationary energy-provision devices EV. The overhead lines 32 are arranged in stationary manner above a roadway 4 on which the vehicle 1 is moving. Instead of the stationary overhead lines 32 above the roadway 4, stationary roadway lines 34—for example, induction loops—as stationary energy-provision devices EV, having the same effect, may have been provided in the roadway 4, via which electrical energy E can likewise be exchanged inductively between the vehicle 1 and the external energy network 30 during travel. Furthermore, charging stations 36 (schematic in FIG. 2) may have been provided as stationary energy-provision devices EV that enable an exchange of electrical energy E between the vehicle 1 and the external energy network 30 even at a standstill of the vehicle 1, for instance in a service area or in a depot.

Supplementally, further vehicles 100 (schematic in FIG. 2) operated by further vehicle operators 101 can also be coupled as energy-users EA onto the charging stations 36 of the energy network 30, so that these further vehicles 100 can also access electrical energy E from the energy network 30. According to one configuration, there may be provision that the further vehicles 100 as energy-users EA can also be directly electrically connected to the vehicle 1, so that electrical energy E can be exchanged directly between the two vehicles 1, 100. Energy E can therefore generally be exchanged between the vehicle 1 and a certain energy-user EA (energy network 30, further vehicle 100, et cetera) by an indirect or direct electrical connection, this taking place, in particular, within the scope of an energy service DL, as will be explained in more detail later.

The electrical energy E is transmitted or made available at the charging stations 36 in the energy network 30 in the form of a predetermined network voltage U30 with a certain network frequency f30 via the overhead lines 32 or the roadway lines 34. Depending upon the degree of utilization L of the energy network 30, the network frequency f30 lies within a frequency band fB, for instance between 49.8 Hz and 50.2 Hz around a center frequency fM of 50 Hz.

Via at least one energy-collector 5, the vehicle 1 can couple onto the overhead lines 32 or onto the charging station 36 or onto the further vehicle 100 mechanically, or onto the roadway lines 34 inductively. In this connection, a device that is capable of being coupled mechanically or inductively is understood to be an energy-collector 5, via which energy E can be taken off in both directions, so that an exchange of energy E can take place. According to the embodiment shown, for this purpose the towing vehicle 1a exhibits a towing-vehicle slide rail 5a as energy-collector 5 for the overhead lines 32, and the trailer 1b exhibits a trailer slide rail 5b as energy-collector 5 for the overhead lines 32, which may each bear against the overhead line 32 in sliding manner during travel, in order to enable a transmission of energy or a collection of energy. A pantograph, for instance, can provide for the mechanical coupling.

However, there may also be provision that only one of the two vehicle parts 1a, 1b exhibits an energy-collector 5 in the form of a slide rail, in order to enable a transmission of energy. In addition, differently realized energy-collectors 5 may also have been provided that similarly enable a transmission of electrical energy E between the vehicle 1 and the overhead line 32 during travel.

As represented in FIG. 1 as an example of the trailer 1b, an inductive energy collector 5c may have been provided as energy-collector 5 for the roadway line 34, in order to enable a contactless inductive transmission of energy E between the energy network 30 and the vehicle 1. This inductive energy-collector 5c may also have been provided, supplementally or alternatively, in the towing vehicle 1a.

As represented in FIG. 2, for the mechanical coupling onto a charging station 36 or onto a further vehicle 100, a coupling 5d as energy-collector 5 may have been arranged on the vehicle 1 (towing vehicle 1a and/or trailer 1b). Via the coupling 5d, an electrical connection to the respective energy-user EA (30, 100) can be established with an appropriate charging cable 5e, in order to enable a collection or exchange of energy E in the respective direction. Via a communications line in the charging cable 5e, signals, for example with additional information, can also be transmitted between the vehicle 1 and the respective energy-user EA.

The electrically-powered or partially electrically-powered vehicle 1 exhibits several energy-storage units 7, in which connection, according to the embodiment shown in FIG. 1 and FIG. 2, a towing-vehicle energy-storage unit 7a is arranged in the towing vehicle 1a, and a trailer energy-storage unit 7b is arranged in the trailer 1b. Via these units, the towing vehicle 1a and also the trailer 1b can be supplied with energy E autonomously during travel, in particular in order to propel the vehicle 1 electrically, at least temporarily. The towing-vehicle energy-storage unit 7a makes electrical energy E available having a towing-vehicle voltage U1a, and the trailer energy-storage unit 7b makes a trailer voltage U1b available. The energy-storage units 7a, 7b can be recharged before the journey at the charging station 36 or during travel by taking in braking energy EB (regeneration). As explained in more detail later, a recharging via the overhead line 32 or via the roadway line 34 during travel is also possible.

For this purpose, the energy-storage units 7; 7a, 7b are capable of being suitably connected to the energy-collector(s) 5 or to the slide rails 5a, 5b or to the inductive energy-collector 5c or to the coupling 5d in the respective vehicle part 1a, 1b. As a result, an exchange of energy E between one or both energy-storage units 7a, 7b and the energy network 30 via the stationary overhead lines 32 or the stationary roadway lines 34 or the stationary charging station 36 is supplementally possible. This includes both a transmission of energy E (U1a, U1b) from the respective energy-storage unit 7; 7a, 7b into the overhead lines 32 or the roadway line 34 or the charging station 36, in order to feed energy E (U1a; U1b) from the vehicle 1 into the energy network 30, and a transmission of energy E (U30, f30) from the overhead lines 32 or the roadway lines 34 or the charging stations 36 into the respective energy-storage unit 7; 7a, 7b, in order to recharge the latter from the energy network 30. Corresponding remarks apply in the case of a direct electrical connection to a further vehicle 100. Hence a bidirectional transmission of energy has been provided, which can be guaranteed appropriately by the infrastructure in the vehicle 1.

Supplementally, converter devices 9 may have been provided in the vehicle 1, a towing-vehicle converter device 9a having been provided in the towing vehicle 1a, and a trailer converter device 9b having been provided in the trailer 1b, the converter devices being arranged between the respective energy-storage unit 7; 7a, 7b and the respective slide rail 5a, 5b or the coupling 5d as energy-collector 5. In the same way, this may also have been provided for the inductive energy-collector 5c (not represented explicitly). These devices serve to transform the towing-vehicle voltage Ula or the trailer voltage U1b into the network voltage U30, or conversely. In the same way, via these devices the towing-vehicle voltage U1a or the trailer voltage U1b, which are present in the form of a DC voltage in the energy-storage units 7; 7a, 7b, can be transformed into an AC voltage (network voltage U30) having the network frequency f30, for example via an inverter in the respective converter device 9. Conversely, via these devices the AC voltage (network voltage U30) can be transformed into a corresponding DC voltage (towing-vehicle voltage U1a or the trailer voltage U1b). If the energy network 30 is being operated with direct current, no transformation via an inverter is necessary, but at most an adaptation of the respective voltage-level U1a, U2b, U30.

Furthermore, electrical switching devices 11 are arranged in the vehicle 1, an electrical towing-vehicle switching device 11a being provided in the towing vehicle 1a, and an electrical trailer switching device 11b being provided in the trailer 1b, these devices being arranged between the respective energy-storage unit 7; 7a, 7b and the respective slide rail 5a, 5b (FIG. 1) or the coupling 5d (FIG. 2) as energy-collector 5. In the same way, for the inductive energy-collector 5c there is also provision that it has been connected to an electrical switching device 11 of such a type (not represented explicitly). The electrical switching devices 11 serve to connect the respective energy-storage unit 7; 7a, 7b electrically optionally to the respective slide rail 5a, 5b or to the inductive energy-collector 5c or to the coupling 5d as energy-collector 5, or to isolate it electrically therefrom. As a result, depending upon the switching position of the respective electrical switching device 11; 11a, 11b, a transmission of energy E from the energy-storage units 7; 7a, 7b via the respective slide rail 5a, 5b or the coupling 5d or the inductive energy collector 5c as energy-collector 5 into the overhead line 32 or the roadway line 34 or the charging station 36 or the further vehicle 100, or conversely, can be enabled or prohibited. The mechanical contact between the respective slide rail 5a, 5b and the overhead line 32, or the connection between the coupling 5d and the energy-user EA (30, 100) via the charging cable 5e, or the inductive connection between the inductive energy-collector 5c and the roadway line 34, can be preserved regardless of the switching position, in order to enable a rapid exchange of energy as soon as the electrical switching device 11; 11a, 11b is triggered appropriately.

The respective electrical switching device 11; 11a, 11b is preferably electrically triggered, directly or indirectly, as a function of a coupling signal SK—that is, a towing-vehicle coupling signal SKa or a trailer coupling signal SKb. The respective coupling signal SK; SKa, SKb transmits the information as to whether the respective energy-storage unit 7; 7a, 7b is to be electrically connected, or not, to the overhead line 32 or to the roadway line 34 or to the charging station 36 or to the energy network 30 or to the further vehicle 100. Correspondingly, a switching of the electrical switching device 11; 11a, 11b takes place in the towing vehicle 1a and/or in the trailer 1b.

The coupling signal SK; SKa, SKb is generated by a processing unit 13 which, for instance, may have been realized as a centrally arranged vehicle-internal processing unit 13Z in the vehicle 1— that is, in the trailer 1b and/or in the towing vehicle 1a—or as an external processing unit 13E outside the vehicle 1. The generation of the coupling signal SK; SKa, SKb takes place via a program or software S which has been installed in the respective processing unit 13. In the case of an external processing unit 13E, this may also be done, for instance, via a cloud infrastructure, via which, for example by software as a service (SaaS), software S capable of being utilized jointly can be accessed, where appropriate with subprograms, which undertakes the generation of the coupling signal SK; SKa, SKb.

The generation of the coupling signal SK; SKa, SKb is dependent on certain rules which can be set by a network operator 33 of the energy network 30 but also by a vehicle operator 2 of the vehicle 1. Accordingly, the network operator 33 can set the conditions under which a transmission of energy E from the energy network 30 into the energy-storage units 7; 7a, 7b—that is, in a first energy-transmission direction R1 (recharging mode)—or a transmission of energy E from the energy-storage units 7; 7a, 7b into the energy network 30—that is, in a second energy-transmission direction R2 (infeed mode)—is possible. At the same time, the vehicle operator 2 can also set the conditions under which energy E can be, or is permitted to be, exchanged in the respective energy-transmission direction R1, R2. Conditions may be, for instance, a storage-unit status S7 of the energy-storage units 7; 7a, 7b and/or an energy price P set by the network operator or by the vehicle operator, or a degree of utilization L of the energy network 30, as explained later.

Depending on the established rules or on the satisfied or unsatisfied conditions, a direction-dependent approval FG—that is, a network-operator approval FG33 and/or a vehicle-operator approval FG2—can be granted which specifies whether or not the respective operator 33, 2 permits an exchange of energy E, and in which energy-transmission direction R1, R2 such an exchange of energy E is to be allowed or authorized. Depending on the approval FG; FG2, FG33, in turn the respective coupling signal SK; SKa, SKb is generated and output, so that a switching of the respective electrical switching device 11; 11a, 11b can take place, and hence an exchange of energy E in the respective energy-transmission direction R1, R2 can be enabled or authorized.

Within the scope of a method according to the invention, this described infrastructure can be used to exchange energy E purposefully for a certain application between the energy-storage units 7; 7a, 7b in the vehicle 1 and the energy network 30 and/or a further vehicle 100 via the stationary energy-provision device EV—that is, the overhead line 32 or the roadway lines 34 or the charging station 36—or via a direct connection. By this means, an energy service DL can be provided by the vehicle operator 2 during travel or at a standstill.

By an “energy service DL”, it is understood, for example, that the vehicle 1 makes its energy-storage units 7; 7a, 7b available in order to take in energy E from an energy-user EA, for example from the energy network 30 or directly from a further vehicle 100, or to output energy E to such an energy-user EA or to make energy E available to the energy-user. The energy E made available can then be used, for example, for charging another vehicle 100 via a direct connection (charging cable 5e) or indirectly via the stationary energy-provision devices EV (32, 34, 36) onto which the further vehicle 100 can likewise be coupled. However, the energy E made available may also have been provided for the purpose of stabilizing the energy network 30 in the event of an overloading as a consequence of a plurality of further vehicles 100 that are taking energy E from the energy network 30.

An intake of energy E by the energy-storage units 7; 7a, 7b in the vehicle 1 may, for instance, have been provided if another energy-user EA possesses surplus energy E which it cannot employ itself in economically sensible manner and which therefore is to be “preserved” or stored at a different place, for example in the energy-storage units 7; 7a, 7b of the vehicle 1. This also implies, for instance, that the energy network 30 is underloaded—that is, is holding “too much” energy E—so that fluctuations in the degree of utilization L of the energy network 30 can be balanced out by an intake of energy E from the energy network 30, and hence a stable energy network 30 in a state of equilibrium can be ensured.

In addition to these energy services DL capable of being provided by the vehicle operator 2, the network operator 33 can also make its stationary energy-provision devices EV available, in order to make energy available, if need be, in a regular operation of the vehicle 1 for a recharging of the energy-storage units 7; 7a, 7b, or for propulsion assistance. However, this does not then constitute an energy service DL provided by the vehicle operator 2 in the sense of the invention, but rather constitutes an independent energy-provision service on the part of the network operator 33.

The energy service DL can be provided, in principle, in an arbitrary running condition of the vehicle 1, to the extent that the energy service DL does not impair the respective (current or future) running condition of the vehicle 1. Accordingly, if the vehicle 1 is being propelled electrically by the energy-storage units 7; 7a, 7b, the energy-storage unit 7; 7a, 7b can, irrespective of the propulsion state of the vehicle 1, take in energy E from the energy network 30 or output surplus energy E into the energy network 30 for the purpose of stabilization and/or for the purpose of making energy E available for other vehicles 100 connected up to the energy network 30, in order to provide the energy service DL without the operation of the vehicle being impaired thereby.

If the vehicle 1 is decelerated and if, as a result, regenerative power or braking energy EB is available, the respective energy-storage unit 7; 7a, 7b can take in this braking energy EB fully, or the respective energy-storage unit 7; 7a, 7b, can take in only a part of the braking energy EB and output the remainder into the energy network 30 or output the entire braking energy EB transformed by regeneration into the energy network 30. Supplementally in this case, stored energy E can additionally be output from the respective energy-storage unit 7; 7a, 7b into the energy network 30.

Furthermore, at a standstill of the vehicle 1 in the case of surplus available energy E, because, for example, sufficient braking energy EB was taken in during travel and a full energy-storage unit 7; 7a, 7b is not absolutely essential for a future continuation of the journey, energy E can be made available to other energy-users EA via the respective stationary energy-provision device EV or via a direct connection. However, this should be done only up to a set residual charging capacity KR of, for instance, 20%, in order to be able to ensure a reliable continuation of the journey of the vehicle 1 as far as the nearest charging option.

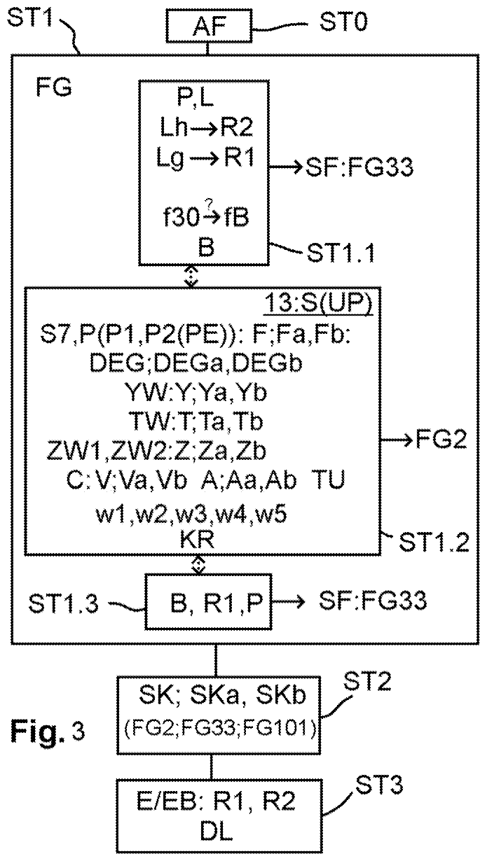

According to FIG. 3, the provision of the energy service DL can be guaranteed by the following steps:

Firstly, in an initial step STO a request AF for the provision of an energy service DL by the vehicle operator 2 is detected by the processing unit 13. This can be done, for instance, by a contact (mechanical, inductive) being actively set up from an energy-user EA to the respective energy-collector 5 in the vehicle 1. Alternatively, or supplementally, a request signal SA can also be communicated to the processing unit 13 in wireless manner, for instance by 5G or WLAN, LoRaWAN, et cetera, or in hard-wired manner, for instance via PLC (power-line communication) or via the communications line in the charging cable 5e. The request signal SA then contains the corresponding request AF for the provision of the energy service DL. For this purpose the processing unit 13 exhibits a communications unit 15 via which various signals can be exchanged in wireless or hard-wired manner. Thereupon it is checked in the processing unit 13 whether or not an exchange of energy E can take place, as follows:

Firstly, in a first step ST1 it is checked whether an approval FG was granted. This includes a network-operator approval FG33 (ST1.1; ST1.3) and/or a vehicle-operator approval FG2 (ST1.2), which may be correlated with one another. Depending on this, in a second step ST2 a coupling signal SK; SKa, SKb for the towing vehicle 1a and/or for the trailer 1b is generated and output via the processing unit 13, externally (13E) or centrally in the vehicle 1 (13Z), in order to establish an electrical connection and hence to enable an exchange of energy E. Depending upon the granted approval FG; FG33, FG2, this may also imply that only one of the two energy-storage units 7a, 7b in the vehicle 1 is being connected to the energy network 30 or to the further vehicle 100. In a third step ST3, the exchange of energy subsequently takes place, wherein, depending upon the granted approval FG; FG33, FG2, energy E is transmitted in the respective energy-transmission direction R1, R2, in order to provide the respective energy service DL.

The steps are run through successively, so that the exchange of energy can also be adapted in the event of a retracted or amended approval FG; FG33; FG2, in order to react, for instance, to fluctuations in the degree of utilization L of the energy network 30, and/or to alterations of a storage-unit status S7 of the respective energy-storage unit 7; 7a, 7b, and/or to an amended energy price P.

The granting of a network-operator approval FG33 by the network operator 33 of the energy network 30 can, as already indicated, be carried out in accordance with a first substep ST1.1 as a function of the degree of utilization L of the energy network 30. If the energy network 30 is being heavily utilized—or, to be more exact, has a high degree of utilization Lh—because many vehicles are taking in energy E via the overhead line 32 or the roadway line 34 or the charging station 36, this results in a falling network frequency f30. Since the network frequency f30 should lie within the specified frequency band fB, the network operator 33 can react by a network-operator approval FG33 within the scope of the energy service DL being granted, at least for some vehicles, temporarily only for the second energy-transmission direction R2. On the other hand, a low degree of utilization Lg of the energy network 30 may obtain, because only a few vehicles are taking in energy E and, where appropriate, a plurality of vehicles are feeding energy E into the energy network 30. This has the consequence that the network frequency f30 rises. In order to keep the network frequency f30, here too, within the predetermined frequency band fB, the network operator 33 can react by a network-operator approval FG33 within the scope of the energy service DL being granted, at least for some vehicles, temporarily only for the first energy-transmission direction R1.

Accordingly, it can be set via the network-operator approval FG33 that the vehicle 1 may only feed energy E from its energy-storage units 7; 7a, 7b into the energy network 30 or may only utilize energy E from the energy network 30 for the purpose of charging the energy-storage units 7; 7a, 7b, in order to compensate for the high or low degree of utilization Lh, Lg of the energy network 30. In this case, an offer is accordingly made to the vehicle 1—or, to be more exact, to the vehicle operator 2—to provide an appropriate energy service DL in order to ensure a permanent stabilization of the energy network 30. At first, this is independent of whether sufficient energy E is available in the vehicle 1 or whether the vehicle 1 actually needs energy E. This is because the vehicle operator 2 can subsequently decide for itself whether the energy service DL is implemented or declined, as explained in more detail later (see substep ST1.2). Supplementally, the energy E taken into the energy-storage unit 7; 7a, 7b within the scope of this energy service DL can be utilized by the vehicle 1 itself also in regular operation.

The network-operator approval FG33, which takes effect as a function of the degree of utilization L in the respective energy-transmission direction R1, R2, can be notified to the communications unit 15 in the external or in the vehicle-internal processing unit 13E; 13Z via an approval signal SF, preferably in wireless manner, for instance by 5G or WLAN, LoRaWAN, et cetera, or in hard-wired manner, for instance via PLC or via the communications line in the charging cable 5e. Depending on this, the external or the vehicle-internal processing unit 13 E; 13Z can subsequently decide whether in a second step ST2 a coupling signal SK; SKa, SKb for the respective electrical switching device 11; 11a, 11b in the towing vehicle 1a and/or in the trailer 1b is generated and output, in order to be able to provide the energy service DL. Depending upon the type of network-operator approval FG33, a selective switching of the respective electrical switching device 11; 11a, 11b can also be carried out merely in the towing vehicle 1a or in the trailer 1b.

In principle, however, the vehicle 1, or the external or vehicle-internal processing unit 13E; 13Z, can also infer autonomously whether a network-operator approval FG33 obtains. For this purpose there may be provision that the network frequency f30 is measured continuously by the vehicle 1, for example via the respective energy-collector 5 (mechanical, inductive). On the other hand, the network operator 33 might also communicate the network frequency f30 to the vehicle 1 continuously. On the basis of this, the respective processing unit 13E; 13Z can establish whether the network frequency f30, starting from the center frequency fM of, for instance, 50 Hz, deviates upward or downward and at the same time lies within the frequency band fB, in which connection the center frequency fM and the frequency band fB can likewise be communicated by the network operator 33. As already described, the degree of utilization L follows directly from this. Depending on this, in the external or vehicle-internal processing unit 13 E; 13Z the energy-transmission direction R1, R2 in which a network-operator approval FG33 should obtain with high probability (Lh: fB<fM: infeed mode, Lg: fB>fM: recharging mode) can be established. Depending on this, the respective processing unit 13 E; 13Z can, in turn, decide whether a, and which, coupling signal SK; SKa, SKb is output in the second step ST2.

The granting of a vehicle-operator approval FG2 by the vehicle operator 2 of the vehicle 1 takes place, as already indicated, in accordance with a second substep ST1.2, in particular as a function of an energy price P and/or as a function of a storage-unit status S7 of the energy-storage units 7; 7a, 7b. The storage-unit status S7 specifies the state in which the respective energy-storage unit 7; 7a, 7b is to be found, whereas the energy price P reflects the costs for a certain energy service DL. The energy price P is ascertained in vehicle-specific or storage-unit-specific manner in a cost-calculation module 50 in the processing unit 13 of the respective vehicle 1. The cost-calculation module 50 is, for instance, a subunit of the respective processing unit 13, for instance a subprogram UP of the software S.

Via an appropriate configuration of the cost-calculation module 50, the vehicle operator 2 can set the price conditions or economic conditions under which it would like to provide an energy service DL by taking in or outputting energy E from or to an energy-user EA (30, 100) into or out of the respective energy-storage unit 7; 7a, 7b, and therefore can set the economic conditions under which the operator ultimately grants a vehicle-operator approval FG2. This applies to both energy-transmission directions R1, R2, as follows:

Firstly, for the purpose of characterizing the storage-unit status S7 for each energy-storage unit 7; 7a, 7b, a status factor F; Fa (towing-vehicle status factor), Fb (trailer status factor) can be ascertained, which, as explained later, is ascertained in a manner depending on whether the infeed mode or the recharging mode obtains—that is, whether energy E is to be output or taken in within the scope of the energy service DL. From this, it follows, firstly, whether a state of degeneration DEG; DEGa (state of degeneration of the towing vehicle), DEGb (state of degeneration of the trailer) and also a state of charge Z; Za, Zb of the respective energy-storage unit 7; 7a, 7b permit that energy E in the infeed mode can be output, for example into the energy network 30, and also in the recharging mode can be taken into the respective energy-storage unit 7; 7a, 7b. The status factor F; Fa, Fb is determined as follows:

Firstly, a state of charge Z of the energy-storage unit 7—that is, a towing-vehicle state of charge Za of the towing-vehicle energy-storage unit 7a, or a trailer state of charge Zb of the trailer energy-storage unit 7b—is registered by a state watchdog 17 in the vehicle 1. From this, a current-intake state-of-charge value ZW1, which may lie between 0 (empty or 0%) and 1 (full or 100%), and a current-output state-of-charge value ZW2, which may lie between 0 (full or 100%) and 1 (empty or 0%), can be ascertained. By virtue of the subdivision into current-intake state-of-charge value and current-output state-of-charge value ZW1, ZW2, it is taken into account that in the case of a current intake (first energy-transmission direction R1, recharging mode) a full energy-storage unit 7; 7a, 7b is to be assessed differently, particularly with regard to the energy price P following therefrom, than a full energy-storage unit 7; 7a, 7b in the case of a current output (second energy-transmission direction R2, infeed mode). This is reflected by the correspondingly inverted weighting.

Furthermore, a storage-unit temperature T of the energy-storage unit 7—that is, a towing-vehicle storage-unit temperature Ta of the towing-vehicle energy-storage unit 7a and a trailer storage-unit temperature Tb of the trailer energy-storage unit 7b—is monitored by the state watchdog 17, in particular during the charging and discharging processes. From this, a temperature-state value TW is ascertained which may assume a value between 0 (for example, at T=30° C.) and 1 (for example, at T>=80° C. and T<20° C.), in which connection for T >80° C. and T<−20° C. it is assumed that the respective energy-storage unit 7; 7a, 7b is no longer working optimally (increased wear and increased susceptibility to defects), and this unit functions optimally at T=30° C.

Furthermore, a charging and discharging behavior V of the energy-storage unit 7—that is, a towing-vehicle charging and discharging behavior Va of the towing-vehicle energy-storage unit 7a and a trailer charging and discharging behavior Vb of the trailer energy-storage unit 7b—is ascertained by the state watchdog 17, for instance via the change in current, voltage or resistance of the respective energy-storage unit 7; 7a, 7b in the course of charging or discharging. Via this, the state of degeneration DEG; DEGa, DEGb of the respective energy-storage unit 7; 7a, 7b can be specified.

The state watchdog 17 has been connected to the processing unit 13 in arbitrary manner 7, preferably via the communications unit 15, in order to be able to output the respectively ascertained values, which have an influence on the state of degeneration DEG; DEGa, DEGb, via a state signal SZ in wireless manner, for instance by 5G or WLAN, LoRaWAN, et cetera, or in hard-wired manner, for instance via PLC or via the communications line in the charging cable 5e, to the processing unit 13 for further processing.

Furthermore, a cycle stability Y; Ya (towing-vehicle cycle stability); Yb (trailer cycle stability) of the respective energy-storage unit 7; 7a, 7b, which specifies how frequently the respective energy-storage unit 7; 7a, 7b can be charged and discharged before a residual capacity falls below a value of 80%, is read in by the processing unit 13 via the state signal SZ. A cycle-stability value YW assigned to the cycle stability Y; Ya, Yb may lie between 0 (high cycle stability, for example >10,000 charging/discharging cycles) and 1 (low cycle stability Y, for example <1000 charging/discharging cycles). Furthermore, a storage-unit age A of the energy-storage unit 7—that is, a towing-vehicle storage-unit age Aa of the towing-vehicle energy-storage unit 7a and a trailer storage-unit age Ab of the trailer energy-storage unit 7b—can be read in via the state signal SZ. From this, it can be deduced how old the respective energy-storage unit 7; 7a, 7b already is. Further quantities that have an influence on the storage-unit status S7 can also be read in by the processing unit 13 via the state signal SZ via the communications unit 15—for instance, an ambient temperature TU or the towing-vehicle voltage U1a and/or the trailer voltage U1b.

The status factor F; Fa, Fb can be calculated in the processing unit 13 with these quantities, for instance via the following formula:

F=(w1*(w2*YW+w3*TW+w4*C(V, A, U1a, U2a, TU))+(w5*(ZW1; ZW2))

where the quantities YW, TW and C characterize the state of degeneration DEG; DEGa, DEGb of the respective energy-storage unit 7; 7a, 7b, and various influencing factors V, A, U1a, U2a, TU, which may have an influence on the state of degeneration DEG; DEGa, DEGb, have been collected in the value C. Also in the case of the influencing factors C, it can be taken into account whether a recharging mode or an infeed mode obtains—that is, the energy-transmission direction R1, R2 in which energy E is transmitted within the scope of the energy service DL can be taken into account.

Correspondingly, “w1” represents a weighting for the state of degeneration DEG; DEGa, DEGb of the respective energy-storage unit 7; 7a, 7b, and “w5” represents a weighting for the state of charge Z; Za, Zb of the respective energy-storage unit 7; 7a, 7b, the current-intake state-of-charge value or the current-output state-of-charge value ZW1, ZW2 of the respective energy-storage unit 7; 7a, 7b being used, depending upon the energy-transmission direction R1, R2, where “w1” and “w5” may each be, for instance, 0.5, so that the state of degeneration DEG; DEGa, DEGb and the state of charge Z (ZW1 or ZW2) have the same influence on the status factor F. Correspondingly, “w2” represents a weighting for the cycle stability Y; Ya, Yb of the respective energy-storage unit 7; 7a, 7b, “w3” represents a weighting for the storage-unit temperature T; Ta, Tb of the respective energy-storage unit 7; 7a, 7b, and “w4” represents a weighting for the further influencing factors C.

The status factor F; Fa, Fb can be determined for each energy-storage unit 7; 7a, 7b, the individual values YW, TW, C being weighted specifically, depending on the type of the respective energy-storage unit 7; 7a, 7b, where w2+w3+w4=1 and w1+w5=1 are to hold.

The status factor F; Fa, Fb ascertained in such a manner may assume a value between 0 and 1. A status factor F; Fa, Fb of 1 in the infeed mode (second energy-transmission direction R2, current-output state-of-charge value ZW2) expresses that the respective energy-storage unit 7; 7a, 7b is not ready for operation (discharged and/or degenerated), whereas a status factor F; Fa, Fb of 0 in the infeed mode (second energy-transmission direction R2, current-output state-of-charge value ZW2) specifies that the respective energy-storage unit 7; 7a, 7b is as good as new (not degenerated) and 100% charged and is therefore ready for operation. Intermediate values result correspondingly from a partial discharge and/or a partial degeneration. Depending on the status factor F; Fa, Fb, which characterizes the storage-unit status S7, for the current output or infeed or the current-output state-of-charge value ZW2, it can be assessed by the processing unit 13 whether a feeding of energy E from the respective energy-storage unit 7; 7a, 7b into the energy network 30 or, generally, an output of energy E to the respective energy-user EA (30, 100) for the purpose of providing the energy service DL is sensible.

Correspondingly, in the case of reversed weighting of the current-intake state-of-charge value ZW1 in comparison with the current-output state-of-charge value ZW2, a status factor F; Fa, Fb of 1 in the recharging mode (first energy-transmission direction R1, current-intake state-of-charge value ZW1) expresses that the respective energy-storage unit 7; 7a, 7b is not ready for operation (fully loaded and/or degenerated), and a status factor F; Fa, Fb of 0 in the recharging mode (first energy-transmission direction R1, current-intake state-of-charge value ZW1) expresses that the respective energy-storage unit 7; 7a, 7b is as good as new (not degenerated) and fully discharged and is therefore ready for operation. Depending on the status factor F; Fa, Fb, for the current intake or the current-intake state-of-charge value ZW1 it can be assessed by the processing unit 13 whether an intake of energy E from the energy network 30 or, generally, from the respective energy-user EA (30, 100) into the respective energy-storage unit 7; 7a, 7b is sensible, in order to provide the respective energy service DL.

Accordingly, if the energy-storage units 7; 7a, 7b have, for instance, already been almost fully charged, corresponding to a high-status factor F; Fa, Fb, taking the current-intake state-of-charge value ZW1 into account, an intake (recharging mode) of further energy E from an energy-user EA (30, 100) is not sensible. No more sensible is the output (infeed mode) of energy E in the case of a lowly charged energy-storage unit 7; 7a, 7b, corresponding to a high-status factor F; Fa, Fb, taking the current-output state-of-charge value ZW2 into account, in which case it also has to be taken into account whether the vehicle 1 itself might possibly need the energy E in the near future. Accordingly, a vehicle-operator approval FG2 for a transmission of energy as a function of the respective status factor F; Fa, Fb, which characterizes the respective storage-unit status S7, can be granted selectively for one or both energy-storage units 7; 7a, 7b in the respective energy-transmission direction R1, R2, or not, in order to provide the respective energy service DL, or not.

From the status factor F; Fa, Fb with ZW1 or ZW2, in addition to the determination of the storage-unit status S7 in the cost-calculation module 50 of the processing unit 13, it is also deduced whether, or when, it is justified from an economic point of view to output energy E in the infeed mode or to take it up in the recharging mode. In connection with this consideration, the state of degeneration DEG; DEGa, DEGb of the respective energy-storage unit 7; 7a, 7b, which advances with every charging and discharging process, so that the monetary value of the respective energy-storage unit 7; 7a, 7b decreases, is also crucial. In addition, the speed of a charging and discharging process has an effect on the state of degeneration DEG; DEGa, DEGb of the respective energy-storage unit 7; 7a, 7b. An energy service DL that has been provided accordingly has a cost disadvantage for the vehicle operator 2, even without the energy E being utilized for operating the vehicle 1, by reason of a decrease in value of the energy-storage unit 7; 7a, 7b.

In order to take this into account, an energy price P is fixed by the cost-calculation module 50 that the vehicle operator 2 should demand at least per kWh (kilowatt hour) transmitted, in order that the energy service DL (for example, compensating for the degree of utilization L of the energy network 30 or the recharging of a further vehicle 100) pays off for the vehicle operator 2 when the operator provides this energy service DL. Depending on this energy price P, the vehicle operator 2 can then grant a vehicle-operator approval FG2, to the extent that the respective energy-user EA has consented to this energy price P by an appropriate approval FG33, FG101.

The energy price P may be composed of the acquisition costs as well as the associated depreciation of the respective energy-storage unit 7; 7a, 7b, in which connection a state of degeneration DEG; DEGa, DEGb of the energy-storage unit 7; 7a, 7b can also be taken into account supplementally for the purpose of estimating the decrease in value. The vehicle operator 2 can set a fixed energy price P for exchanged energy E directly, or can alternatively undertake a dynamic adaptation of the energy price P.

A dynamic adaptation can be derived from the status factor F; Fa, Fb with ZW1 or ZW2, depending upon the energy-transmission direction R1, R2, since this factor also includes, via the quantities YW, TW, C which specify the state of degeneration DEG; DEGa, DEGb, a measure of the decrease in value of the respective energy-storage unit 7; 7a, 7b. In addition, the state of charge Z; Za, Zb is also crucial for the proffered energy price P, since for reasons of decrease in value and also for reasons of the vehicle's own utilization a withdrawal from a full energy-storage unit 7; 7a, 7b is more favorable than the withdrawal from a half-full energy-storage unit 7; 7a, 7b. Therefore the following formula for the energy price P can be formulated, which the vehicle operator 2 saves in the cost-calculation module 50:

P1=PE×(1−F(ZW1)) or P2=PE×(1+F(ZW2))

where PE represents a currently available purchase price for energy E, for example 30 cents for 1 kWh, P1 represents an intake-energy price, and P2 represents an output-energy price. Accordingly, a distinction is made, according to whether the vehicle 1 is taking in energy E from the respective energy-user EA (30, 100) (intake-energy price P1) or outputting it from its energy-storage units 7; 7a, 7b to the respective energy-user EA (30, 100) (output-energy price P2). Via the respective state-of-charge value ZW1, ZW2, it is taken into account that, for instance, a further intake of energy E in the case of a full energy-storage unit 7; 7a, 7b is more expensive than the output of energy E in the case of a full energy-storage unit 7; 7a, 7b. The vehicle operator 2 of the vehicle 1 can also set further parameters and hence can weight the purchase price PE appropriately, this being done by an appropriate adaptation of the above formula for the energy price P (P1, P2) in the cost-calculation module 50.

The difference in price between intake and output also results from the fact that, in the case of a transmission of energy E into the energy network 30 from the energy-storage units 7; 7a, 7b, on the one hand energy E is made available which other vehicles (can) use and which these vehicles also make payment for to the network operator 33 correspondingly, and on the other hand an energy service DL is also provided (for example, stabilizing the energy network 30, feeding in additionally needed energy E). In the case of an intake of energy E from the energy network 30 or from a further vehicle 100, the energy service DL is offset appropriately against the purchase price PE. In this connection, the influence of the status factor F; Fa, Fb can also be differently weighted appropriately.

The energy price P can be updated continuously by the cost-calculation module 50 on the basis of the quantities output to the processing unit 13 by the state watchdog 17 or via the state signal SZ, for example on the basis of the charging and discharging behavior V; Va, Vb. In this way, it is ensured that, for example in the case of a fast-discharging process—for example, greater than 50 kW—the energy price P is higher than in the case of a slow discharge, for example less than 50 kW, so that the discharging of the respective energy-storage unit 7; 7a, 7b by reason of a more rapidly advancing state of degeneration DEG; DEGa, DEGb of the energy-storage unit 7; 7a, 7b is prevented from becoming more expensive than what is earned by virtue of the respective energy service DL. Furthermore, the storage-unit age A; Aa, Ab may also have an influence on the energy price P, the state of degeneration DEG; DEGa, DEGb of an older, already depreciated energy-storage unit 7; 7a, 7b no longer having any influence on its decrease in value, so that a lower energy price P can be fixed.

The state of charge Z; Za, Zb itself may also have an influence, since the vehicle operator 2 is more likely to be prepared to output energy E in the case of a high battery charge than in the case of a low battery charge, also for the reason that the state of charge Z; Za, Zb of the respective energy-storage unit 7; 7, 7b should optimally be kept between 40% and 80%, in order to avoid too rapid a progression of the state of degeneration DEG. In addition, a residual charging capacity KR of, for instance, 20% is also to be kept in reserve, in order for the vehicle to be able to continue to travel by itself in future. This applies correspondingly in inverse manner to an intake of energy E, in which connection in the case of a low battery charge, for example less than 40%, the willingness to take in is higher than in the case of a high battery charge, for example >80%, the higher/lower willingness being reflected correspondingly in a lower/higher energy price P. Via a correspondingly higher energy price P, it can also be taken into account that the state of degeneration DEG of the energy-storage unit 7; 7a, 7b is impaired more rapidly during a charging or discharging process at a high current storage-unit temperature T; Ta, Tb.

The vehicle operator 2 accordingly grants an appropriate vehicle-operator approval FG2 for performing the energy service DL at the respective energy price P which is ascertained continuously in the cost-calculation module 50. For this purpose the energy price P can be communicated to the respective energy-user EA via the communications unit 15 in wireless manner, for instance by 5G or WLAN, LoRaWAN, et cetera, or in hard-wired manner, for instance via PLC or via the communications line in the charging cable 5e. Supplementally, individual quantities that are contained in the state signal SZ can be communicated to the energy-user EA, so that the user can itself, where appropriate, better comprehend the energy price P.

The respective energy-user EA, for example the network operator 33, can then, depending on the communicated energy price P, maintain its network-operator approval FG33 or retract it if the energy price P is, for example, too high for it. The vehicle operator 101 of the further vehicle 100 as energy-user EA can also grant or deny an appropriate user approval FG101 if the operator would like to lay claim to the energy service DL at the predetermined energy price P, or not. On the basis of the respective approvals FG2, FG33, FG101 granted in price-dependent manner, in the second step ST2 the processing unit 13 can then generate a coupling signal SK; SKa, SKb for the respective electrical switching device 11; 11a, 11b in the towing vehicle 1a and/or in the trailer 1b, and can output the signal to the switching device 11; 11a, 11b in wireless or hard-wired manner, so that the energy service DL can be provided to the respective energy-user EA (30, 100).

In a third substep ST1.3, in parallel with the provision of the energy service DL, or instead of it, a network-operator approval FG33 can also be granted which serves to recharge the respective energy-storage unit 7; 7a, 7b in the vehicle 1, so that energy E can be made available from the energy network 30 for the electrical propulsion of the vehicle 1 in regular operation. If the vehicle 1 needs energy E from the overhead line 32 or from the roadway line 34 or from the charging stations 36 or generally from the energy network 30, the vehicle can withdraw the energy from the energy network 30 if a network-operator approval FG33 for this obtains. The network-operator approval FG33 can be granted, for example, as a function of the degree of utilization L of the energy network 30. Furthermore, the network-operator approval FG 33 may also have been coupled to the energy price P which in this case the network operator 33 sets. Since the vehicle operator 2 is actively requesting energy E, and the network operator 33 is making this energy E available, the state of degeneration DEG, DEGa, DEGb of the respective energy-storage unit 7; 7a, 7b in this case plays no role in the ascertainment of the energy price P.

In connection with the granting of the network-operator approval FG33 in regular operation, it can also be taken into account in this case whether the vehicle 1 itself has in the past fed energy E from the respective energy-storage unit 7; 7a, 7b into the energy network 30 via the overhead lines 32 or the roadway line 34 or the charging station 36 and has therefore made energy E available from a storage unit also for other vehicles, in order to stabilize the energy network 30. Accordingly, the vehicle 1 can receive an “energy credit”, so to speak, by virtue of the energy service DL provided in the past, which can be employed later in regular operation in order to receive energy for propulsion from the energy network 30. The provision of the energy service DL by the vehicle operator 2 and the regular operation of the vehicle 1 therefore proceed separately from one another in principle, but may also proceed in parallel, at least temporarily.

In a third step ST3, energy E is subsequently either taken in or output, depending upon the approval FG; FG33, FG2, FG101, which, in particular, has been granted in price-dependent manner, and hence depending upon the setting of the electrical switching devices 11; 11a, 11b, in order to provide the respective energy service DL and/or to obtain energy E for propelling the vehicle 1 in regular operation. Crucial, above all, in this connection is the energy-transmission direction R1, R2 for which an approval FG; FG33, FG2; FG101 was granted.

With the method according to the invention it is accordingly guaranteed to make free storage capacities in the vehicle 1, be it the towing vehicle 1a or the trailer 1b or both, available as a buffer to the energy network 30 and/or to a further vehicle 100 under certain conditions, in particular as a function of the energy price P set in the cost-calculation module 50, and hence to provide an energy service DL. In this way, the integration of the stationary energy-provision devices EV—that is, the overhead lines 32 or the roadway lines 34 or the charging stations 36—into the existing network infrastructure can be improved, and simplified operation can be made possible. In this case, a feeding of energy E into the energy network 30 can take place not only when the vehicle 1 is braking and, as a result, generating surplus braking energy EB, but whenever just enough energy E is available in the energy-storage units 7; 7a, 7b in the vehicle 1 and this energy can be made available from an economic point of view. If, for instance, overhead lines 32 or roadway lines 34 are set up or installed on mountainous roadways 4, the vehicles 1 with surplus energy E in their energy-storage units 7; 7a, 7b can assist the vehicles 1 traveling uphill without themselves having to brake.

For this purpose, the energy E from the energy-storage units 7; 7a, 7b that is already being carried and, supplementally, also the braking energy EB generated in the course of downhill travel can be utilized. For it is entirely conceivable that the feeding into the energy network 30 can take place at a time when the vehicle 1 does not need propulsion assistance via the energy-storage units 7; 7a, 7b but the energy-storage units 7; 7a, 7b are fully recharged, and therefore not even additionally generated braking energy EB can be utilized. This surplus energy E can be made appropriately available to the energy network 30. But also at a standstill of the vehicle 1 the surplus energy E can be made available to other vehicles 100 or to the energy network 30 via a direct connection or via a charging station 36.

The described components in the vehicle 1 are independent of a drive-type B (purely electric 1E or hybrid 1H) of the vehicle 1. If, for instance, the vehicle 1 is being operated purely electrically, the energy-storage units 7; 7a, 7b are, in all probability, significantly larger than, for example, in the case of hybrid vehicles 1H. In hybrid vehicles 1H it is additionally possible that in the first substep ST1.1 or third substep ST1.3 in the event of an overloading of the energy network 30 (network frequency f30«center frequency fM) by reason of a demand that is too high the network-operator approval FG 33 in the first energy-transmission direction R1 (30=>7) is selectively retracted for this drive-type B. In this way, individual vehicles 1 can be decoupled from the energy network 30, so that they have to continue traveling with the conventional drive and/or can only feed energy E into the energy network 30. By this means, the energy network 30 can be stabilized again.

If an energy demand still continues to be too high after the decoupling of the hybrid vehicles 1H, the network-operator approval FG33 in the first energy-transmission direction R1 is retracted also for purely electrically-propelled vehicles 1E having energy-storage units 7; 7a, 7b that have a state of charge Z; Za, Zb that exceeds a limiting state of charge ZT, and/or having a status factor F; Fa, Fb that exceeds a limiting status factor FT. These vehicles 1 are then appropriately decoupled from the energy network 30, since they are also capable of making progress on their own. These purely electrically-propelled vehicles 1 can then decide to provide an energy service DL for the purpose of stabilizing the energy network 30, and to feed energy E from the energy-storage units 7; 7a, 7b into the energy network 30 in the second energy-transmission direction R2.

Hence the network-operator approval FG33 can also be granted as a function of the drive-type B and/or as a function of the state of charge Z; Za of the respective vehicle 1 and, where appropriate, can also subsequently be retracted.

It is understood that the foregoing description is that of the preferred embodiments of the invention and that various changes and modifications may be made thereto without departing from the spirit and scope of the invention as defined in the appended claims.

### LIST OF REFERENCE SYMBOLS (PART OF THE DESCRIPTION)

1 vehicle

1a towing vehicle

1b trailer

1E fully electrically-propelled vehicle

1H hybrid vehicle

2 vehicle operator

3 energy-transmission system

4 roadway

5 energy-collector

5a slide rail of towing vehicle

5b slide rail of trailer

5c inductive energy-collector

5d coupling

5e charging cable

7 energy-storage unit

7a energy-storage unit of towing vehicle

7b energy-storage unit of trailer

9 converter device

9a converter device of towing vehicle

9b converter device of trailer

11 electrical switching device

11a electrical switching device of towing vehicle

11b electrical switching device of trailer

13 processing unit

13E external processing unit

13T central processing unit

15 communications unit

17 state watchdog

30 energy network

31 power distributor

32 overhead line

33 network operator

34 roadway lines

36 charging station

50 cost-calculation module

100 further vehicle

101 further vehicle operator

A age of energy-storage unit 7

Aa age of storage unit of towing vehicle

Ab age of storage unit of trailer

AF request for provision of energy service DL

B drive-type

C influencing factors

DEG state of degeneration of energy-storage unit

DEGa state of degeneration of towing vehicle

DEGb state of degeneration of trailer

DL energy service

E electrical energy

EA energy-user

EB braking energy

EV stationary energy-provision device

f30 network frequency

fB frequency band

fM center frequency

F status factor of energy-storage unit 7

Fa status factor of towing vehicle

Fb status factor of trailer

FG approval

FG2 vehicle-operator approval

FG33 network-operator approval

FG101 user approval

FT limiting status factor

KR residual charging capacity

L degree of utilization

Lg low degree of utilization

Lh high degree of utilization

P energy price

P1 intake-energy price

P2 output-energy price

PE purchase price

R1 first energy-transmission direction

R2 second energy-transmission direction

S software

S7 storage-unit status

SA request signal

SF approval signal

SK coupling signal

SKa coupling signal of towing vehicle

SKb coupling signal of trailer

SZ state signal

T temperature of storage unit

Ta temperature of storage unit of towing vehicle

Tb temperature of storage unit of trailer

TU ambient temperature

TW temperature-state value

U1a voltage of towing vehicle

U1b voltage of trailer

U30 network voltage

UP subprogram

V charging and discharging behavior of energy-storage unit 7

Va charging and discharging behavior of towing vehicle

Vb charging and discharging behavior of trailer

w1, w2, w3, w4, w5 weighting factors

Y cycle stability

Ya cycle stability of towing vehicle

Yb cycle stability of trailer

YW cycle-stability value

Z state of charge of energy-storage unit 7

Za state of charge of towing vehicle

Zb state of charge of trailer

ZT limiting state of charge

ZW1 current-intake state-of-charge value

ZW2 current-output state-of-charge value

ST0, ST1, ST1.1, ST1.2, ST1.3, ST2, ST3 steps of the method

1. A method for exchanging electrical energy between an energy-storage unit in a vehicle, operated by a vehicle operator, and an energy-user, wherein the energy-storage unit has been configured to store electrical energy long-term, and an electrical connection between the energy-storage unit and the energy-user can be configured to exchange energy, the method comprising:
exchanging energy from the energy-user into the energy-storage unit in a first energy-transmission direction or from the energy-storage unit to the energy-user in a second energy-transmission direction in order to provide an energy service by the vehicle operator, wherein said exchanging energy takes place as a function of an energy price, set by the vehicle operator, for the energy service, wherein the energy price is ascertained as a function of a storage-unit status of the energy-storage unit.

2. The method of claim 1, wherein the energy price is set as a function of whether, for a purpose of providing the energy service, the energy is transmitted in the first energy-transmission direction or in the second energy-transmission direction.

3. The method of claim 2, wherein the energy price for the energy service includes at least one of an intake-energy price and an output-energy price, wherein:
the intake-energy price specifies the energy price for the transmission of energy in the first energy-transmission direction; and,
the output-energy price specifies the energy price for the transmission of energy in the second energy-transmission direction.

4. The method of claim 3, wherein the energy price for the energy service is dependent on at least one of a status factor and a purchase price for energy, wherein the status factor characterizes a current storage-unit status of the energy-storage unit.

5. The method of claim 4, wherein the status factor is generated as a function of at least one of a state of degeneration of the energy-storage unit and a state of charge of the energy-storage unit; the at least one of state of degeneration and the state of charge is weighted for ascertaining the status factor; and, the state of charge is dependent on the energy-transmission direction.

6. The method of claim 5, wherein the state of degeneration of the energy-storage unit is ascertained as a function of at least one quantity selected from a group including: a storage-unit temperature, a charging and discharging behavior, a cycle stability, a storage-unit age, an ambient temperature, a towing-vehicle voltage, a trailer voltage; and, said at least one quantity is weighted differently, as a function of the energy-storage unit being used, for ascertaining the state of degeneration.

7. The method of claim 1, wherein at least one of a separate energy price and a storage-unit status has been assigned to the energy-storage unit.

8. The method of claim 1, wherein at least one of the storage-unit status and the energy price for the energy service is determined statically or dynamically.

9. The method of claim 1 further comprising:
generating and outputting a coupling signal as a function of at least one of the storage-unit status assigned to the energy-storage unit and of the energy price set by the vehicle operator for the energy service; and,
depending on the coupling signal, forming an electrical connection on the vehicle between the energy-storage unit and an energy collector connected to the energy-user.

10. The method of claim 9, wherein said electrical connection is formed via a switching device in the vehicle.

11. The method of claim 9, wherein the coupling signal is generated in the vehicle or generated outside the vehicle and is transmitted to the vehicle in wireless or hard-wired manner.

12. The method of claim 1, wherein the energy is exchanged between the energy-storage unit and the energy-user in a case where an electrical connection has been formed via an overhead line or a roadway line or a charging station or a charging cable.

13. The method of claim 1, wherein the energy service includes at least one of a compensation of a degree of utilization of an energy network as energy-user, a provision of energy for assisting a further vehicle as energy-user, and a preservation of surplus energy of an energy-user.

14. The method of claim 13, wherein the degree of utilization of the energy network may lie between a high degree of utilization and a low degree of utilization; and, in a case of a high degree of utilization of the energy network, an exchange of energy in the second energy-transmission direction takes place, and in a case of a low degree of utilization of the energy network, an exchange of energy in the first energy-transmission direction takes place, in order to compensate for the high degree of utilization or the low degree of utilization of the energy network.

15. The method of claim 1 further comprising:
ascertaining whether an approval by the energy-user is present, wherein the approval specifies whether the respective energy-user allows, for a purpose of providing the energy service, energy to be transmitted selectively in at least one of the first energy-transmission direction and the second energy-transmission direction,
wherein the approval is granted by the energy-user as a function of at least one property; and,
wherein the at least one property is at least one of:
a vehicle-type of the vehicle, a degree of utilization of the energy-user, the storage-unit status assigned to the energy-storage unit, and the energy price set for the energy service by the vehicle operator.

16. The method of claim 4, wherein the intake-energy price=the purchase price×(1−the status factor); and, the output-energy price=the purchase price×(1+the status factor).

17. A processing unit comprising:
a processor;
a non-transitory storage medium having program code stored thereon for exchanging electrical energy between an energy-storage unit in a vehicle, operated by a vehicle operator, and an energy-user, wherein the energy-storage unit has been configured to store electrical energy long-term, and an electrical connection between the energy-storage unit and the energy-user can be configured to exchange energy;
said program code being configured, when executed by said processor, to exchange energy from the energy-user into the energy-storage unit in a first energy-transmission direction or from the energy-storage unit to the energy-user in a second energy-transmission direction in order to provide an energy service by the vehicle operator, wherein said exchanging energy takes place as a function of an energy price, set by the vehicle operator, for the energy service, wherein the energy price is ascertained as a function of a storage-unit status of the energy-storage unit;
the processing unit being configured to generate and output a coupling signal such that the electrical connection between the energy-storage unit in the vehicle and the energy-user can be formed, in order to enable said exchange of energy from the energy-user into the energy-storage unit in the first energy-transmission direction, or from the energy-storage unit of the vehicle to the energy-user in the second energy-transmission direction, for the provision of the energy service by the vehicle operator; and,
a cost-calculation module configured to generate the coupling signal as a function of an energy price set for the energy service; and,
said cost-calculation module being configured to ascertain an energy price for the energy service as a function of a storage-unit status of the energy-storage unit.

18. The processing unit of claim 17 further comprising:
a communications unit, wherein at least one of:
the processing unit is configured to transmit the energy price via said communications unit to the energy-user; and,
the energy-user is configured to communicate to the processing unit via said communications unit whether an approval has been granted by the energy-user, wherein the approval specifies whether the energy-user allows, for a purpose of providing the energy service, energy to be transmitted at the set energy price optionally in at least one of the first energy-transmission direction and the second energy-transmission direction.

19. A vehicle comprising:
at least one electrical switching device;
at least one energy-storage unit;
at least one energy-collector capable of being connected to said at least one energy-storage unit;
said energy-collector being configured to be coupled with an energy-user within a scope of a provision of an energy service;
said energy-storage unit being configured to store electrical energy long-term;
said at least one electrical switching device being configured to form, depending on a coupling signal output by the processing unit of claim 17, an electrical connection between said at least one energy-storage unit and said at least one energy-collector, to enable an exchange of energy, as a function of an energy price, set by the vehicle operator, for the energy service, between said at least one energy-storage unit and said energy-user capable of being coupled, wherein the energy price has been set as a function of a storage-unit status of said at least one energy-storage unit.

20. The vehicle of claim 19, wherein the coupling signal is capable of being generated and output by a vehicle-internal processing unit or is capable of being transmitted to the vehicle in wireless or hard-wired manner by an external processing unit.

21. The vehicle of claim 19, wherein the vehicle includes a towing vehicle and at least one trailer, wherein at least one of a towing-vehicle energy-storage unit is arranged in the towing vehicle and a trailer energy-storage unit is arranged in the at least one trailer; and, at least one of the towing-vehicle energy-storage unit and the trailer energy-storage unit is capable of being connected to the energy-user as a function of the coupling signal.

22. The vehicle of claim 19, wherein the vehicle is a hybrid vehicle or a fully electrically-propelled vehicle.

23. The vehicle of claim 19, wherein the vehicle includes a towing vehicle and at least one trailer, wherein at least one of a towing-vehicle energy-storage unit is arranged in the towing vehicle and a trailer energy-storage unit is arranged in the at least one trailer; and, at least one of the towing-vehicle energy-storage unit and the trailer energy-storage unit is capable of being selectively connected to the energy-user as a function of the coupling signal.
